(19) United States
(12) Patent Application Publication
(10) Pub. No.: US 2025/0226511 A1
(43) Pub. Date: Jul. 10, 2025

(54) BATTERY PACK AND POWER TOOL

(71) Applicant: Nanjing Chervon Industry Co., Ltd., Nanjing (CN)

(72) Inventors: Qing GAO, Nanjing (CN); Ju Li, Nanjing (CN)

(21) Appl. No.: 19/088,132

(22) Filed: Mar. 24, 2025

Related U.S. Application Data
(63) Continuation of application No. PCT/CN2023/123875, filed on Oct. 11, 2023.

(30) Foreign Application Priority Data
Nov. 9, 2022 (CN) 202211395477.5
Sep. 26, 2023 (CN) 202311252928.4
Sep. 26, 2023 (CN) 202311255477.X

(51) Int. Cl. H01M 50/247; H01M 10/0525; H01M 10/054; H01M 10/42; H01M 50/204; H01M 50/233

(52) U.S. Cl. CPC H01M 50/247; H01M 10/0525; H01M 10/054; H01M 10/4257; H01M 50/204; H01M 50/233

(57) ABSTRACT

A battery pack includes a battery housing; a battery module disposed in the battery housing, where the battery module includes multiple battery cells, and at least one of the battery cells is a solid-state battery; and a control circuit disposed in the battery housing and configured to use the battery module to supply the electric power to the power tool. The energy W of the battery pack and the volume V1 of the battery pack satisfy the following: when the energy W is greater than or equal to 200 Wh, the volume V1 is less than or equal to 400 cm³; or when the energy W is greater than or equal to 300 Wh, the volume V1 is less than or equal to 800 cm³; or when the energy W is greater than or equal to 700 Wh, the volume V1 is less than or equal to 2500 cm³.

### RELATED APPLICATION INFORMATION

This application is a continuation of International Application Number PCT/CN2023/123875, filed on Oct. 11, 2023, through which this application also claims the benefit under 35 U.S.C. § 119(a) of Chinese Patent Application No. 202211395477.5, filed on Nov. 9, 2022, Chinese Patent Application No. 202311255477.X, filed on Sep. 26, 2023, and Chinese Patent Application No. 202311252928.4, filed on Sep. 26, 2023, which applications are incorporated herein by reference in their entireties.

### TECHNICAL FIELD

The present application relates to a battery pack and a power tool, for example, a battery pack that supplies electric power to a power tool, a power tool, a power tool system, a mower, and a sander.

### BACKGROUND

With the development of battery technology, engine tools are gradually replaced with power tools. In order that a cordless power tool has a better use effect, a battery pack is required to have higher output characteristics. For example, to achieve a working effect and a battery lifetime similar to those of an engine tool, increasingly higher requirements are placed on the performance of the battery pack, such as the safety performance, power density, energy density, and life.

### SUMMARY

The present application provides a battery pack for supplying electric power to a power tool. The battery pack includes a battery housing, a battery module, and a control circuit. The battery module is disposed in the battery housing, where the battery module includes multiple battery cells, and at least one of the battery cells is a solid-state battery. The control circuit is disposed in the battery housing and configured to use the battery module to supply the electric power to the power tool. The energy W of the battery pack and the volume V1 of the battery pack satisfy the following: in the case where the energy W of the battery pack is greater than or equal to 200 watt-hours, the volume V1 of the battery pack is less than or equal to 400 cm³; or in the case where the energy W of the battery pack is greater than or equal to 300 watt-hours, the volume V1 of the battery pack is less than or equal to 800 cm³; or in the case where the energy W of the battery pack is greater than or equal to 700 watt-hours, the volume V1 of the battery pack is less than or equal to 2500 cm³.

In some examples, in the case where the energy W of the battery pack is greater than or equal to 350 watt-hours, the weight M1 of the battery pack is less than or equal to 10 kg.

In some examples, the voltage of the battery pack is higher than or equal to 18 volts.

In some examples, the ratio of the energy W of the battery pack to the volume V1 of the battery pack satisfies the relation: 0.2 Wh/cm³≤W/V1≤1 Wh/cm³.

In some examples, the ratio of the energy W of the battery pack to the weight M1 of the battery pack satisfies the relation: 35 Wh/kg≤W/M1≤1 Wh/kg.

In some examples, the ratio of the volume V1 of the battery pack to the volume V2 of the battery module satisfies the relation: 1≤V1/V2≤5.

In some examples, the length L2, width W2, and height H2 of the battery module satisfy the relations: 1≤L2/W2≤2, 1≤L2/H2≤2, and 0.5≤W2/H2≤1.5.

In some examples, the length L2, width W2, and height H2 of the battery module satisfy the relations: 6 cm≤L2≤20 cm, 5 cm≤H2≤15 cm, and 5 cm≤W2≤15 cm.

In some examples, the length L3, width W3, and height H3 of each of the multiple battery cells satisfy the relations: 10≤L3/W3≤100, 10≤L3/H3≤100, and 0.5≤W3/H3≤2.

In some examples, the length L3, width W3, and height H3 of each of the multiple battery cells satisfy the relations: 300 mm≤L3≤900 mm, 10 mm≤H3≤40 mm, and 10 mm≤W3≤40 mm.

The present application provides a battery pack for supplying electric power to a power tool. The battery pack includes a battery housing, a battery module, a first interface, a second interface, and a control circuit. The battery module is disposed in the battery housing, where the battery module includes multiple battery cells, and at least one of the battery cells is a solid-state battery. The first interface is configured to connect the power tool. The second interface is configured to access external electric power for the battery pack. The control circuit is disposed in the battery housing, where the control circuit is electrically connected to the battery module, the first interface, and the second interface separately and is configured to use the battery module or the external electric power to supply the electric power to the power tool.

In some examples, the external electric power is an alternating current.

In some examples, the external electric power is a direct current supplied by an external energy storage device, and the external energy storage device is independent of the battery pack.

In some examples, the external energy storage device is a lithium-ion battery pack.

In some examples, the external energy storage device is a sodium-ion battery pack.

In some examples, the external energy storage device is a battery pack constituted of both a lithium-ion battery and a sodium-ion battery.

In some examples, the external energy storage device is a solid-state battery pack.

In some examples, the first interface and the second interface are on different planes.

In some examples, the first interface and the second interface are on two opposite surfaces of the battery housing.

In some examples, the control circuit is configured to, after the second interface accesses the external electric power, control part of the external electric power to supply electric power to the power tool, control the battery pack to stop supplying the electric power to the power tool, and control part of the external electric power to charge the battery pack.

The present application provides a power tool. The power tool includes a tool body and the battery pack in any one of the preceding examples. The tool body includes a tool housing, an electric motor, and a driver circuit. The electric motor is disposed in the tool housing. The driver circuit is electrically connected to the electric motor and is configured to drive the electric motor. The battery pack is configured to power the driver circuit.

In some examples, the weight of the battery pack is less than or equal to 70% of the weight of the tool body.

In some examples, the tool body further includes a transmission unit configured to transmit power outputted by the electric motor.

In some examples, a projection of the center of gravity of the power tool on a horizontal plane falls within the range of a projection of the battery pack on the horizontal plane.

In some examples, the operable temperature range of the power tool is from −50 degrees Celsius to 90 degrees Celsius.

In some examples, the tool housing includes a grip to be held.

In some examples, the battery pack partially overlaps the grip.

In some examples, the battery pack and the tool body are detachable and mountable relative to each other.

In some examples, the electric motor is a direct current motor.

The present application provides a power tool. The power tool includes a tool body and a battery pack. The tool body includes a tool housing, an electric motor, and a driver circuit. The electric motor is disposed in the tool housing. The driver circuit is electrically connected to the electric motor and is configured to drive the electric motor. The battery pack is configured to power the driver circuit. The battery pack includes a battery housing, a battery module, and a control circuit. The battery module is disposed in the battery housing, where the battery module includes multiple battery cells, and at least one of the battery cells is a solid-state battery. The control circuit is disposed in the battery housing and configured to use the battery module to supply electric power to the power tool. The weight of the battery pack is less than or equal to 70% of the weight of the tool body.

The present application provides a power tool. The power tool includes a tool body and a battery pack assembly. The tool body includes a tool housing, an electric motor, and a driver circuit. The electric motor is disposed in the tool housing. The driver circuit is electrically connected to the electric motor and is configured to drive the electric motor. The battery pack assembly is configured to power the driver circuit. The battery pack assembly includes a first battery pack and a second battery pack. The first battery pack is configured to power at least the driver circuit, the first battery pack includes multiple battery cells, and at least one of the battery cells is configured as a solid-state battery. The second battery pack is configured to power at least one of the first battery pack and the driver circuit.

In some examples, the second battery pack includes multiple battery cells, and at least one of the battery cells is configured as a solid-state battery.

In some examples, the second battery pack includes multiple battery cells, and at least one of the battery cells is configured as a liquid-state battery.

The present application provides a power tool system. The power tool system includes a tool body, a first battery pack, and a second battery pack. The tool body includes a tool interface configured to access electric power. The first battery pack includes a first battery pack housing and a first battery module disposed in the first battery pack housing, where the first battery module includes at least one first battery cell, and each of the at least one first battery cell is a liquid-state battery. The second battery pack includes a second battery pack housing and a second battery module disposed in the second battery pack housing, where the second battery module includes at least one second battery cell, and each of the at least one second battery cell is a solid-state battery. The first battery pack has a first battery interface that matches the tool interface to allow the first battery pack to power the tool body, and the second battery pack has a second battery interface that matches the tool interface to allow the second battery pack to power the tool body.

The present application provides a power tool. The power tool includes a tool body and a second battery pack. The tool body is configured to match a first battery pack so that the tool body is powered through the first battery pack, where the first battery pack includes a first battery pack housing and a first battery module disposed in the first battery pack housing, the first battery module includes at least one first battery cell, and each of the at least one first battery cell is a liquid-state battery. The second battery pack includes a second battery pack housing and a second battery module disposed in the second battery pack housing, the second battery module includes at least one second battery cell, and each of the at least one second battery cell is a solid-state battery. The second battery pack has a second battery interface that matches a tool interface on the tool body to allow the second battery pack to power the tool body.

The present application provides a mower. The mower includes a machine housing, a first electric motor, a travelling device, a second electric motor, a cutting assembly, and an energy storage device. The first electric motor is accommodated in the machine housing, where the first electric motor is a direct current motor. The travelling device includes driving wheels, where the driving wheels are driven by the first electric motor. The second electric motor is accommodated in the machine housing, where the second electric motor is a direct current motor. The cutting assembly includes a blade, where the blade is driven by the second electric motor. The energy storage device is configured to power the first electric motor and the second electric motor. The energy storage device includes an energy storage unit. The energy storage unit includes a solid-state battery.

In some examples, the operable temperature range of the mower is from −20 degrees Celsius to 90 degrees Celsius.

In some examples, the mower further includes a charging port, where the charging port is configured to be connected to another electrical energy source for charging.

In some examples, a charging rate of the mower is from 3 C to 10 C.

In some examples, the energy storage device is a sealed device.

In some examples, the mower is configured to determine an electric quantity of the energy storage device, and in the case where the energy storage device has a small electric quantity, the mower is capable of automatically travelling to a charging pile to be charged.

The present application provides a sander. The sander includes a sander body and a battery pack. The sander body includes a tool housing, an electric motor, and a battery pack interface. The tool housing includes a grip. The electric motor is disposed in the tool housing. The battery pack interface is disposed on the tool housing. The battery pack includes a battery cell and a tool interface. The battery cell includes a solid-state battery. The tool interface is configured to be coupled to the battery pack interface.

In some examples, the battery pack partially overlaps the grip.

In some examples, the battery pack and the sander body are detached and mounted relative to each other.

In some examples, the electric motor is a direct current motor.

In the examples of the present application, the battery pack includes the multiple battery cells, and at least one of the battery cells is the solid-state battery.

### BRIEF DESCRIPTION OF THE DRAWINGS

FIG. 1 is a schematic view of application scenarios of a battery pack in the present application;

FIG. 2 is a perspective view of a power tool according to an example of the present application from a viewing angle;

FIG. 3 is a plan view of the power tool in FIG. 2 from a viewing angle;

FIG. 4 is a structural view of the power tool in FIG. 2 from a viewing angle;

FIG. 5 is a perspective view of a battery pack according to an example of the present application from a viewing angle;

FIG. 6 is an exploded view of a battery pack according to an example of the present application from a viewing angle;

FIG. 7 is a perspective view of a battery cell in FIG. 6 from a viewing angle;

FIG. 8 is a perspective view of a battery pack according to an example of the present application from a viewing angle;

FIG. 9 is an exploded view of a battery pack according to an example of the present application from a viewing angle;

FIG. 10 is a plan view of a power tool according to an example of the present application from a viewing angle;

FIG. 11 is a perspective view of a tool body in FIG. 10 from a viewing angle;

FIG. 12 is a perspective view of a power tool system according to an example of the present application from a viewing angle;

FIG. 13 is a plan view of a power tool according to an example of the present application from a viewing angle;

FIG. 14 is a perspective view of a mower according to an example of the present application from a viewing angle;

FIG. 15 is a schematic view showing part of the structures of the mower in FIG. 14;

FIG. 16 is a schematic view of a sander operated manually according to an example of the present application;

FIG. 17 is a perspective view of a sander according to an example of the present application from a viewing angle; and

FIG. 18 is a sectional view of the sander in FIG. 17.

### DETAILED DESCRIPTION

The present application is described below in conjunction with drawings and examples.

It is to be understood by those skilled in the art that in the disclosure of the present application, orientations or position relations indicated by terms such as “up”, “down”, “front”, “rear”, “left”, and “right” are based on the drawings. These orientations or position relations are intended only to facilitate and simplify the description of the present application and not to indicate or imply that a device or element referred to must have such particular orientations or must be configured or operated in such particular orientations. Thus, the terms are not to be construed as limiting the present application.

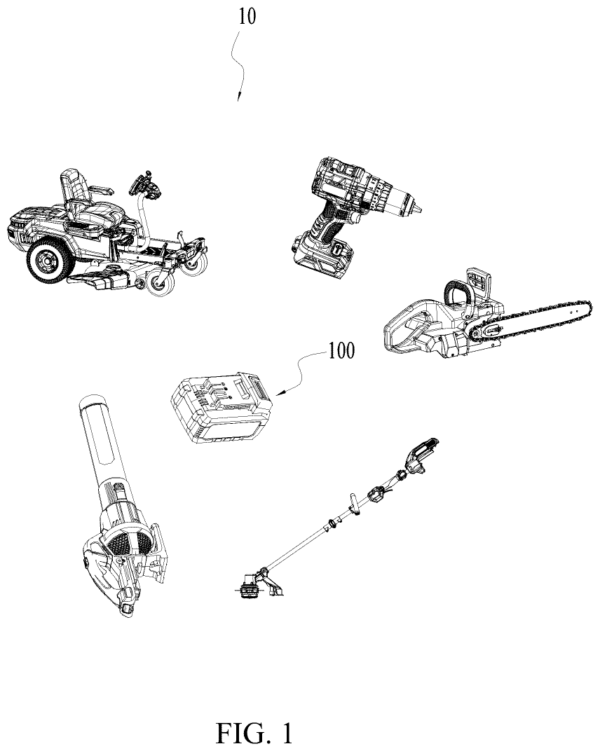

As shown in FIG. 1, a power tool 10 in the present application may be a handheld power tool, a garden tool, or a garden vehicle such as a vehicle-type mower, which is not limited herein. The power tool 10 in the present application includes, but is not limited to, a power tool that requires speed regulation, such as a screwdriver, an electric drill, a wrench, and an angle grinder, a sander and another power tool that may be used for grinding workpieces, a reciprocating saw, a circular saw, a jigsaw and the like that may be used for cutting workpieces, and an electric hammer and another power tool that may be used for impact. These tools may also be garden tools, such as pruners, chainsaws, and vehicle-type mowers. As long as these power tools can adopt the essence of the technical solutions disclosed below, these power tools are within the scope of the present application.

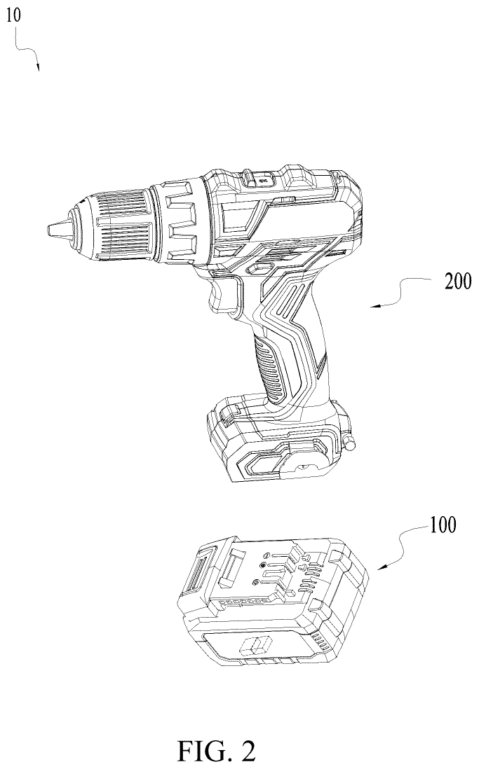

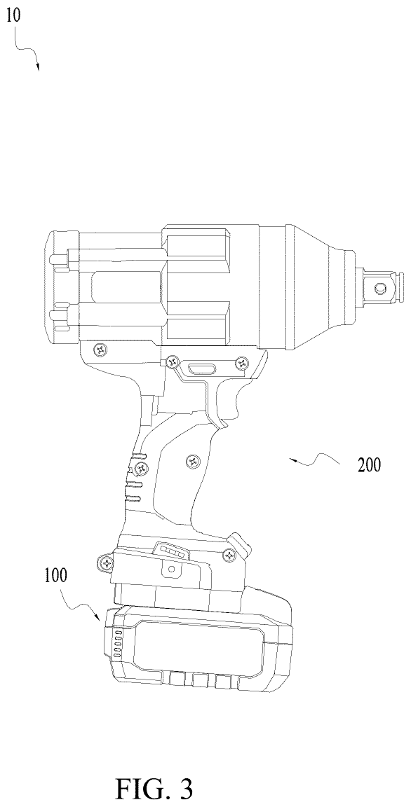

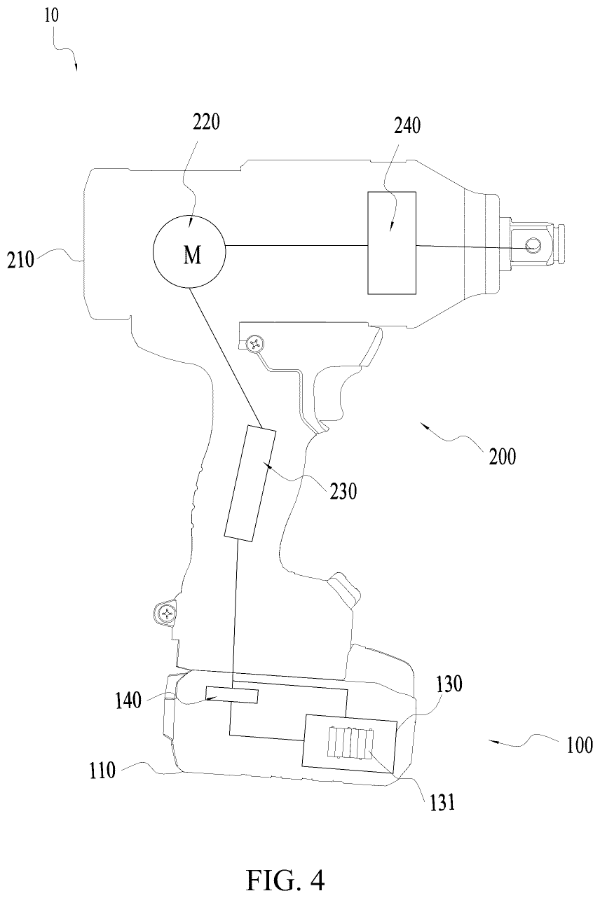

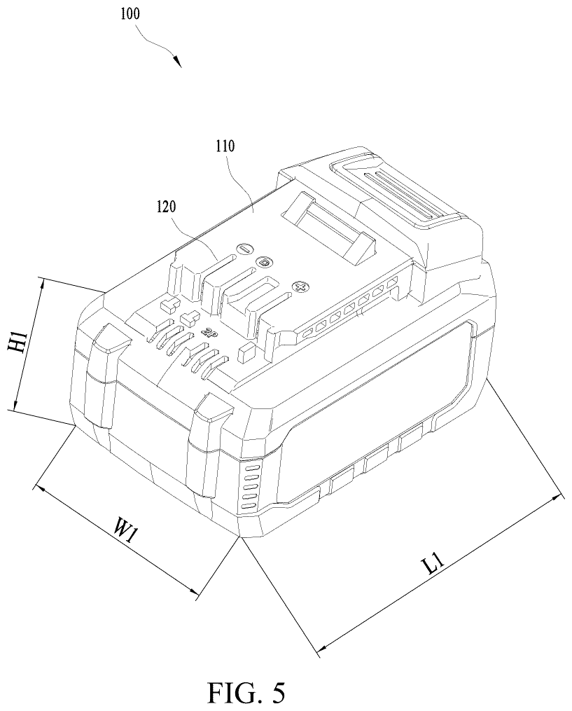

As shown in FIGS. 1 to 4, the power tool 10 includes a battery pack 100 and a tool body 200. The battery pack 100 is configured to supply electric power to the tool body 200. As shown in FIG. 4, the tool body 200 of the power tool 10 includes at least a tool housing 210, an electric motor 220, and a driver circuit 230. The electric motor 220 is disposed in the tool housing 210. The driver circuit 230 is electrically connected to the electric motor 220 and drives the electric motor 220. As shown in FIGS. 5 to 7, as an energy storage device, the battery pack 100 is configured to store electrical energy to power the power tool 10. The present application does not limit the shape of the battery pack 100. The battery pack 100 may be in the shape shown in FIG. 5, may be similar to a cuboid, or may be a cylinder or another three-dimensional structure.

In this example, as shown in FIG. 5, the battery pack 100 has a battery housing 110. A terminal assembly 120 is disposed on the battery housing 110. The terminal assembly 120 is connectable to terminals on the power tool 10, a charger, or an adapter to output the electrical energy stored in the battery pack 100 to the power tool 10 or to charge the battery pack 100 through the charger. In an example, the terminal assembly 120 may include connecting terminals such as a positive terminal, a negative terminal, and a communication terminal. In this example, the terminal assembly 120 is electrically connected to a battery module 130 in the battery pack 100 so that electric power stored in battery cells 131 can be transmitted to the power tool 10 connected to the terminal assembly 120 or electric power transmitted by the charger is transmitted to the battery cells 131 to charge the battery cells 131. In an example, as shown in FIG. 4, the battery pack 100 also has a control circuit 140. The control circuit 140 is disposed in the battery housing 110. The control circuit 140 is electrically connected to the battery module 130 and the tool body 200. The control circuit 140 uses the battery module 130 to supply the electric power to the tool body 200.

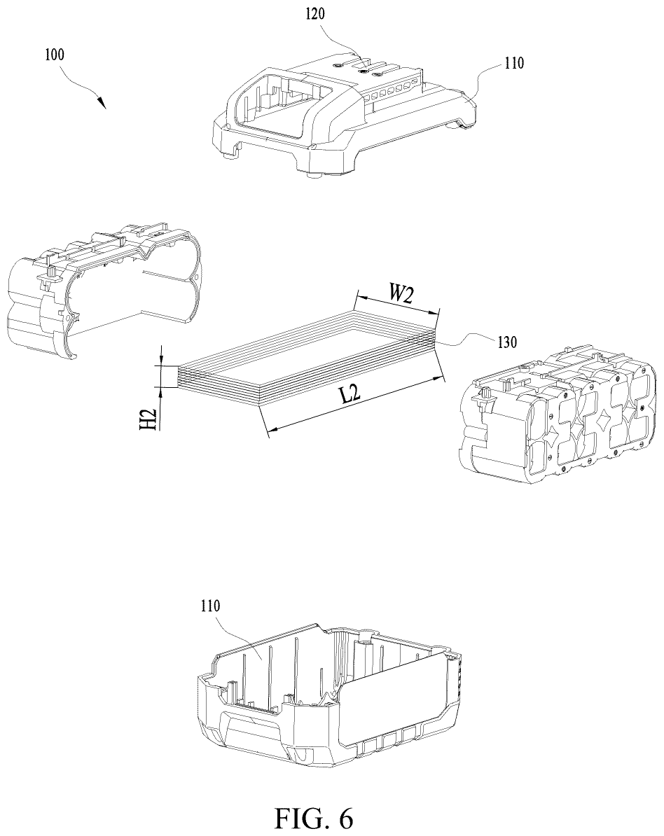

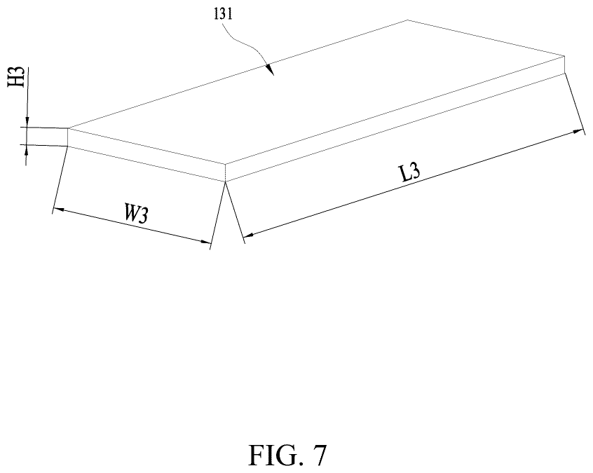

In an example, the battery pack 100 may include the battery module 130. The battery module 130 may be understood as an intermediate unit constituted by the multiple battery cells 131 connected in series and parallel, where the intermediate unit is between a battery cell 131 and the battery pack 100. Each of the battery cells 131, also referred to as a cell, is the smallest unit of a battery system and is mainly constituted by a positive electrode, a negative electrode, an electrolyte, a separator, and a cell housing. The present application does not limit the shape of each of the battery cells 131. Each of the battery cells 131 may be in the shapes shown in FIGS. 6 and 7, may be similar to a cuboid, or may be a cylinder or another three-dimensional structure.

According to the materials of the electrolytes in the battery cells 131, the batteries may be classified into solid-state batteries and liquid-state batteries. A solid-state battery refers to a battery that uses a solid electrolyte. A liquid-state battery refers to a battery that uses a liquid electrolyte. Most of the battery packs used in power tools on the market are liquid-state lithium-ion batteries. Compared with traditional liquid-state lithium-ion batteries, solid-state batteries have the characteristics of being non-flammable, high temperature-resistant, non-corrosive, and non-volatile, avoiding phenomena such as electrolyte leakage and a short circuit of electrodes in traditional liquid-state batteries. Thus, the sensitivity of the battery module to a temperature is reduced, thereby significantly reducing safety risks.

In the examples of the present application, the battery pack 130 includes the multiple battery cells 131, and at least one of the battery cells 131 is a solid-state battery. A battery pack with solid-state batteries has the advantages of high energy density, good safety performance, and a long cycle life. Therefore, the battery pack 100 provided by the present application can supply a larger electric quantity to the power tool 10, has a long service life, and provides safer user experience than a traditional battery pack in the same volume.

The energy of a battery refers to electrical energy outputted by the battery doing work under a certain discharging condition, commonly expressed in a watt-hour (W·h) or a kilowatt-hour (kW·h). The battery pack is used as a power source of the power tool, so the energy and volume of the battery pack are two critical factors that affect user experience. A battery pack with a small volume and a large amount of energy is more convenient for a user to use. In the present application, the solid-state batteries are used as the energy storage device so that the battery pack 100 has a small volume. In addition, the battery pack 100 including the solid-state batteries is used as the power source of the power tool 10, which favors the miniaturization and light loading of the power tool 10 and thus favors the use of the user.

In the examples of the present application, if the energy W of the battery pack 100 is set to be greater than or equal to 350 watt-hours and the volume V1 of the battery pack 100 is set to be less than or equal to 700 cm³, the power tool 10 can satisfy both the user's energy requirement and the user's volume requirement on the power tool 10. Moreover, further facilitation of the miniaturization of the power tool 10 is favored.

In some examples, when the energy W of the battery pack 100 is greater than or equal to 200 Wh, the volume V1 of the battery pack 100 is less than or equal to 400 cm³. In an example, the voltage of the battery pack 100 may be 18 volts (V) or 20 volts, the capacity of the battery pack 100 may be 8 ampere-hours (A·h), and the volume of the battery pack 100 may be less than or equal to 370 cm³. In other examples, optionally, the energy of the battery pack 100 may be 100 Wh, 144 Wh, 150 Wh, 160 Wh, or 200 Wh, and the volume of the battery pack 100 may be 200 cm³, 288 cm³, 300 cm³, 320 cm³, 350 cm³, or 400 cm³.

In some examples, when the energy W of the battery pack 100 is greater than or equal to 300 Wh, the volume V1 of the battery pack 100 is less than or equal to 800 cm³. In an example, the voltage of the battery pack 100 may be 24 volts, the capacity of the battery pack 100 may be 12 ampere-hours, and the volume of the battery pack 100 may be less than or equal to 800 cm³. In other examples, optionally, the energy of the battery pack 100 may be 288 Wh, 300 Wh, 350 Wh, or 400 Wh, and the volume of the battery pack 100 may be 700 cm³, 768 cm³, 780 cm³, or 800 cm³.

In some examples, when the energy W of the battery pack 100 is greater than or equal to 700 Wh, the volume V1 of the battery pack 100 is less than or equal to 2500 cm³. In an example, the voltage of the battery pack 100 may be 56 volts, the capacity of the battery pack 100 may be 12 ampere-hours, and the volume of the battery pack 100 may be less than or equal to 2500 cm³. In other examples, optionally, the energy of the battery pack 100 may be 700 Wh, 800 Wh, 900 Wh, or 1000 Wh, and the volume of the battery pack 100 may be 1500 cm³, 1780 cm³, 2000 cm³, or 2500 cm³.

The preceding examples can also enable the power tool 10 to satisfy both the user's energy requirement and the user's volume requirement on the power tool 10. Moreover, the further facilitation of the miniaturization of the power tool is favored.

In the examples of the present application, if the energy W of the battery pack 100 is set to be greater than or equal to 350 watt-hours and the weight M1 of the battery pack 100 is set to be less than or equal to 10 kg, the power tool 10 can satisfy both the user's energy requirement and the user's volume requirement on the power tool 10. Moreover, further facilitation of lightweight design of the power tool 10 is favored.

The battery pack is a mature energy storage device, so it is very difficult to change the structure or manufacturing process of the battery pack. In the examples of the present application, if the ratio of the energy W of the battery pack 100 to the volume V1 of the battery pack 100 is set to satisfy the relation: 0.1 Wh/cm³≤W/V1≤1 Wh/cm³, or the ratio of the energy W of the battery pack 100 to the weight M1 of the battery pack 100 is set to satisfy the relation: 1 Wh/kg≤W/M1≤35 Wh/kg, the user's requirements for the miniaturization and light loading of the power tool 10 can be not only satisfied but also are not difficult to fulfil since the requirements are not excessively high. In some examples, the ratio of the energy W of the battery pack 100 to the volume V1 of the battery pack 100 may be set to 0.1 Wh/cm³, 0.17 Wh/cm³, 0.21 Wh/cm³, 0.24 Wh/cm³, 0.26 Wh/cm³, 0.28 Wh/cm³, 0.33 Wh/cm³, 0.36 Wh/cm³, 0.41 Wh/cm³, 0.43 Wh/cm³, 0.45 Wh/cm³, 0.53 Wh/cm³, 0.62 Wh/cm³, 0.71 Wh/cm³, 0.83 Wh/cm³, or 0.92 Wh/cm³.

The higher the voltage of the battery pack 100, the higher the power of the power tool 10. In the examples of the present application, if the voltage of the battery pack 100 is set to be higher than or equal to 18 volts, the working requirements of the power tool 10 in most working conditions can be satisfied.

In addition to the battery module 130, functional components are also typically included in the battery pack 100 such as the terminal assembly 120, a battery monitoring and management device, a current transmission member, and assemblies for collecting and transmitting electrical signals and temperature signals. These functional components occupy part of the volume of the battery pack 100, and the battery module 130 occupies the remaining majority of the volume. For the battery pack 100, the higher the ratio of the volume V2 of the battery module 130 to the volume V1 of the battery pack 100, the higher the volumetric energy density of the battery pack 100. However, this also imposes stricter requirements for the miniaturization of the functional components in the battery pack 100, making it more difficult to improve the structure in the existing battery pack 100. In some examples of the present application, if the ratio of the volume V1 of the battery pack 100 to the volume V2 of the battery module 130 is set to satisfy the relation: 1≤V1/V2≤5, the user's requirements for the miniaturization of the power tool 10 can be not only satisfied but also are not difficult to fulfil since the requirements are not excessively high.

As shown in FIG. 5, in an example, the length L1, width W1, and height H1 of the battery pack 100 may satisfy the relations: 1 cm≤L1≤100 cm, 1 cm≤H1≤100 cm, and 1 cm≤W1≤100 cm.

As shown in FIG. 6, in an example, the length L2, width W2, and height H2 of the battery module 130 may satisfy the relations: 1≤L2/W2≤2, 1≤L2/H2≤2, and 0.5≤W2/H2≤1.5. For example, the length L2, width W2, and height H2 of the battery module 130 satisfy the relations: 6 cm≤L2≤20 cm, 5 cm≤H2≤15 cm, and 5 cm≤W2≤15 cm.

As shown in FIG. 7, in an example, the length L3, width W3, and height H3 of each of the multiple battery cells 131 satisfy the relations: 10≤L3/W3≤100, 10≤L3/H3≤100, and 0.5≤W3/H3≤2. For example, the length L3, width W3, and height H3 of each of the multiple battery cells 131 satisfy the relations: 300 mm≤L3≤900 mm, 10 mm≤H3≤40 mm, and 10 mm≤W3≤40 mm.

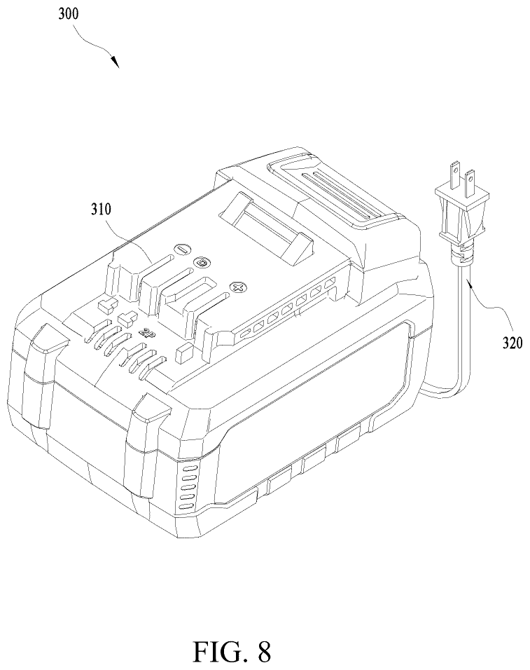

In some working conditions, the energy of the battery pack 100 is insufficient to drive the power tool 10 to work at high power for a long time. If the power tool 10 is caused to stop working to charge the battery pack 100, the user's work efficiency is hindered. With reference to the battery pack 300 shown in FIG. 8, the energy of the battery pack 300 provided by the present application can drive the power tool 10 to work at high power for a long time. The portions in the preceding examples that are compatible with this example may be applied to the battery pack 300 in this example. Only the differences between this example and the preceding examples are described below.

In some examples, as shown in FIG. 8, the battery pack 300 includes a first interface 310 and a second interface 320. The first interface 310 is configured to connect the power tool 10, and the second interface 320 is configured to access external electric power. The control circuit 140 of the battery pack 300 is disposed in the battery housing 110. The control circuit 140 is electrically connected to the battery module 130, the first interface 310, and the second interface 320 separately and uses the battery module 130 or the external electric power to supply the electric power to the power tool 10. In this example, when the electric quantity of the battery pack 300 is insufficient, the user may introduce the external electric power to supply the electric power to the power tool 10, thereby continuing using the power tool 10 to work.

The external electric power may be a commercially available alternating current. The user accesses the alternating current from a power grid to supply the power to the power tool 10. The external electric power may be electric power supplied by an external power supply device independent of the battery pack 300. This electric power may be a direct current directly outputted by the external power supply device or an alternating current converted from the direct current. Optionally, the external power supply device may be a lithium-ion battery pack, a sodium-ion battery pack, or a battery pack constituted of both a lithium-ion battery and a sodium-ion battery. The external power supply device may be a solid-state battery pack.

The first interface 310 of the battery pack 300 is configured to connect the tool body 200, and the second interface 320 is configured to access the external electric power. The battery pack 300 has two signal states: a charging state and a discharging state. When the battery pack 300 is in the charging state, the second interface 320 receives external electrical energy to charge the battery pack 300. When the battery pack 300 is in the discharging state, the first interface 310 supplies the electrical energy from the battery pack 300 to the tool body 200. The battery pack 300 includes a detection terminal. The detection terminal is configured to detect a signal state of the first interface 310 and a signal state of the second interface 320. The first interface 310 has a discharging state and an idle state, and the second interface 320 has a charging state and an idle state. When the second interface 320 is connected to the external electric power, the detection terminal detects that the second interface 320 is in the charging state and sends a charging control signal to the control circuit 140 so that the external electric power is received to charge the battery pack 300. When the first interface 310 is connected to the power tool 10, the detection terminal detects that the first interface 310 is in the discharging state and sends a discharging control signal to the control circuit 140 so that the battery pack 300 supplies the electric power to the power tool 10.

In part of the examples, as shown in FIG. 8, the first interface 310 and the second interface 320 are on different planes. For example, the first interface 310 and the second interface 320 may be on two opposite surfaces of the battery housing 110. In some working conditions, the battery pack 300 may need to introduce the external electric power while powering the power tool 10. The first interface 310 and the second interface 320 are disposed on the two opposite surfaces of the battery housing 110 so that the user can be prevented from confusing the interfaces.

In part of the examples, the control circuit 140 is configured to, after the second interface 320 accesses the external electric power, control part of the external electric power to supply electric power to the power tool 10, control the battery pack 300 to stop supplying the electric power to the power tool 10, and control part of the external electric power to charge the battery pack 300. The battery pack 300 is charged while supplying the electric power to the power tool 10, which shortens the life of the battery pack 300. After the external electric power is accessed, the battery pack 300 is caused to stop discharging electricity, and the external electric power is used for supplying the electric power to the power tool 10. Thus, it can be ensured that the user continuously works, and the service life of the battery pack 300 is prevented from being shortened.

The present application provides a battery pack 400 that can support the power tool 10 in working in a high-power mode. The portions in the preceding examples that are compatible with this example may be applied to the battery pack 400 in this example. Only the differences between this example and the preceding examples are described below.

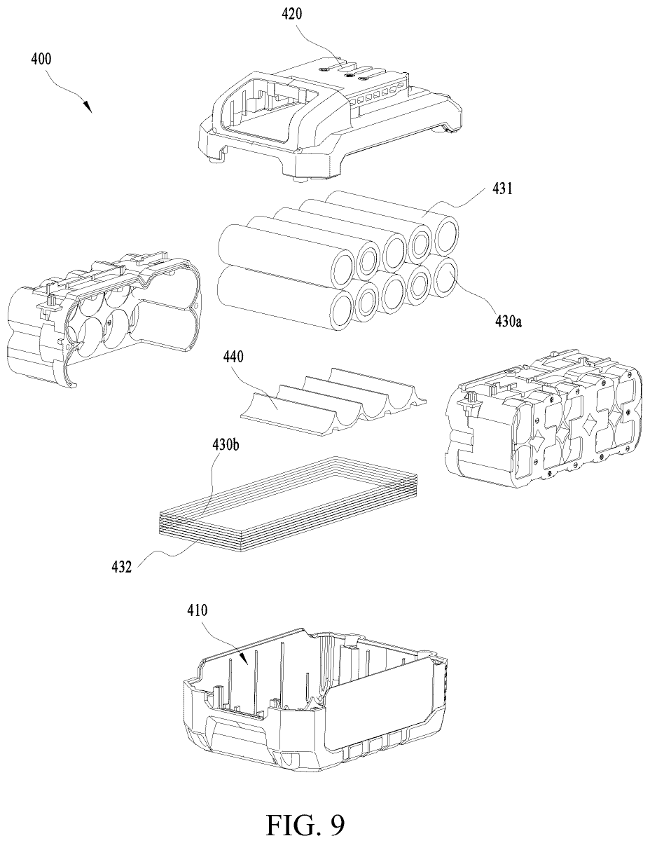

As shown in FIG. 9, in this example, the battery module 430 in the battery pack 400 may include at least first battery cells 431 and second battery cells 432. In this example, the first battery cells 431 and the second battery cells 432 are disposed in the battery housing 410 and are supported by the housing. The first battery cells 431 and the second battery cells 432 may be completely different from each other or part of the characteristics of the first battery cells 431 and the second battery cells 432 are the same as each other. For example, the electrolyte of each of the first battery cells 431 is a liquid, and the electrolyte of each of the second battery cells 432 is a solid. The power density of each of the first battery cells 431 is higher than the power density of each of the second battery cells 432, and the energy density of each of the second battery cells 432 is higher than the energy density of each of the first battery cells 431. In an example, the power density of each of the first battery cells 431 is higher than or equal to 250 W/kg. The energy density of each of the second battery cells 432 is higher than or equal to 400 Wh/kg. In an example, each of the first battery cells 431 may be a lithium iron phosphate liquid-state battery, a ternary lithium liquid-state battery, or a sodium-ion battery, and each of the second battery cells 432 may be a lithium-ion solid-state battery or a sodium-ion solid-state battery. In an example, the battery pack 400 further includes a terminal assembly 420. The terminal assembly 420 may include connecting terminals. The connecting terminals are electrically connected to the first battery cells 431 and the second battery cells 432 to transmit the electrical energy from the battery module 430 to the power tool 10.

The battery module 430 in this example is constituted by the liquid-state batteries and the solid-state batteries. Compared with the design where all the battery cells in the battery module are solid-state batteries, the battery module 430 in this example has higher power density. Compared with the design where all the battery cells in the battery module are liquid-state batteries, the battery module 430 in this example has higher energy density. The battery module 430 in this example is constituted by the liquid-state batteries and the solid-state batteries so that the battery pack 400 can have high energy density and can also support the power tool 10 in working in the high-power mode.

In an optional implementation, the first battery cells 431 may be connected in series or parallel to the second battery cells 432. In an optional implementation, the first battery cells 431 are connected in series to form a first branch, the second battery cells 432 are connected in series to form a second branch, and the first branch and the second branch are connected in parallel. In an optional implementation, the first battery cells 431 and the second battery cells 432 may be connected in parallel and then in series. In this example, other types of electrical connection manners may exist between the two types of battery cells and are not listed here one by one.

In an optional implementation, the first battery cells 431 and the second battery cells 432 may be completely different from each other or part of the characteristics of the first battery cells 431 and the second battery cells 432 are the same as each other. For example, each of the first battery cells 431 may have first energy and a first cycle life, and each of the second battery cells 432 may have second energy and a second cycle life. A cycle life may refer to the number of charging and discharging cycles that a battery cell can perform while maintaining a certain energy output and may also be referred to as the service life of the battery. The first energy is different from the second energy, and the first cycle life is different from the second cycle life. In this example, the first cycle life is longer than the second cycle life, and the first energy is less than the second energy. In an example, the ratio of the first cycle life to the second cycle life is higher than or equal to 2, and the ratio of the first energy to the second energy is lower than or equal to 0.8. That is to say, each of the first battery cells 431 has the characteristics of a longer service life but less energy, and each of the second battery cells 432 has a shorter service life but greater energy.

In an optional implementation, as shown in FIG. 9, the battery module 430 may include at least a first module 430a and a second module 430b. The first battery cells 431 are connected to each other such that the first module 430a is formed. The second battery cells 432 are connected to each other such that the second module 430b is formed. The first module 430a and the second module 430b are electrically connected in series or parallel. The same type of battery cell is used in each of the first module 430a and the second module 430b, which can be convenient for the control circuit 140 to sample, detect, and perform consistency management on the batteries. In an example, the first module 430a powers the power tool 10, and the second module 430b powers the first module 430a. In an example, the second module 430b powers the power tool 10, and the first module 430a powers the second module 430b.

The applicant has found through research that the charging and discharging rate performance of a solid-state battery is relatively low because the conductivity of the solid-state battery is low at a room temperature. The present application provides an example in which a heating device may be provided to increase a battery temperature. Thus, the problem is solved that it is difficult for the solid-state battery to support, at room and low temperatures, the power tool in working in the high-power mode.

As shown in FIG. 9, in this example, the battery pack 400 includes a heating device 440. The heating device 440 is configured to heat the solid-state battery. After the solid-state battery is heated, the conductivity increases, and the power density and the charging and discharging rate performance also increase accordingly. Thus, the solid-state battery can support the power tool 10 in working in the high-power mode.

In an optional implementation, the control circuit 140 further includes a temperature detection module and a controller. The temperature detection module is configured to detect the temperature of the solid-state battery. The controller is at least electrically connected to the heating device 440. The controller is configured to acquire the temperature outputted by the temperature detection module. The controller is configured to, when the temperature is lower than a first temperature threshold, control the heating device 440 to start so as to heat the solid-state battery. The controller is configured to, when the temperature is higher than or equal to a second temperature threshold, control the heating device 440 to stop heating.

In an optional implementation, the controller is configured to acquire the temperature outputted by the temperature detection module. The controller is configured to, when the temperature is lower than the first temperature threshold, control the heating device 440 to start so as to heat the second battery cells 432. The controller is configured to, when the temperature is higher than or equal to the second temperature threshold, control the heating device 440 to stop heating. In an example, at least one first battery cell 431 supplies electric power to the heating device 440 to heat the second battery cells 432.

In an optional implementation, the second module 430b powers the power tool 10, and the first module 430a powers at least the heating device 440. In an example, after the power tool 10 is started, the power tool 10 may control the first module 430a, which has relatively high conductivity at the room temperature, to heat the second module 430b. After the temperature of the second module 430b increases, the conductivity of the second module 430b increases. The controller may control the second module 430b, which has relatively high energy density, to power the power tool 10. In an example, the controller is configured to, when the temperature is lower than the first temperature threshold, control the first module 430a to power the heating device 440 so as to heat the second module 430b; and the controller is configured to, when the temperature is higher than or equal to the second temperature threshold, control the second module 430b to power the power tool 10.

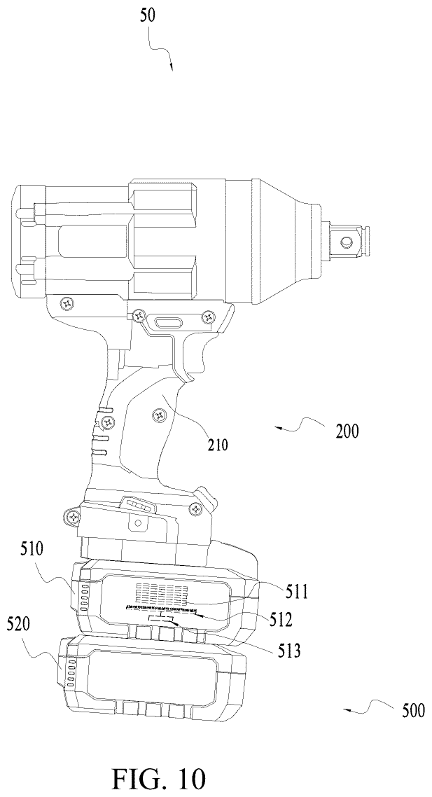

Referring to a power tool shown in FIG. 10, the present application further provides the power tool 50. The power tool 50 includes a tool body 200 and a battery pack 500. The battery pack 500 is configured to supply electric power to the tool body 200. The portions in the preceding examples that are compatible with this example may be applied to this example, and only the differences between this example and the preceding examples are described below.

The battery pack 500 includes a battery housing 110, a battery module 130, and a control circuit 140. The battery module 130 is disposed in the battery housing 110. The control circuit 140 is disposed in the battery housing 110 and uses the battery module 130 to supply the electric power to the power tool 50. The battery module 130 includes multiple battery cells 131 and at least one of the battery cells 131 is a solid-state battery. The battery pack of the present application may be the battery pack in any of the preceding examples. The details are not repeated here.

In some examples, as shown in FIG. 10, the battery pack 500 includes a first battery pack 510 and a second battery pack 520. The first battery pack 510 powers at least a driver circuit 230, the first battery pack 510 includes multiple battery cells 511, and at least one of the battery cells 511 is configured as a solid-state battery. The second battery pack 520 powers at least the driver circuit 230 or the first battery pack 510. The battery pack 500 includes the first battery pack 510 and the second battery pack 520 so that a larger electric quantity can be supplied to the power tool 50, thereby prolonging the working time of the power tool 50.

In some examples, due to the low conductivity of the solid-state battery at the room temperature, the first battery pack 510 further includes a heating device 512. The heating device 512 of the battery pack 500 may be configured to heat the solid-state battery. After the solid-state battery is heated, the conductivity increases, and the power density and the charging and discharging rate performance also increase accordingly. Thus, the solid-state battery can support the power tool 50 in working in the high-power mode.

In an optional implementation, the first battery pack 510 further includes a temperature detection module 513. The temperature detection module 513 is configured to detect the temperature of the solid-state battery. The power tool 50 is configured to acquire the temperature outputted by the temperature detection module 513. The power tool 50 is configured to, when the temperature is lower than a first temperature threshold, control the heating device 512 to start so as to heat the solid-state battery. The power tool 50 is configured to, when the temperature is higher than or equal to a second temperature threshold, control the heating device 512 to stop heating.

In an optional implementation, the power tool 50 is configured to, when the temperature is lower than the first temperature threshold, control the second battery pack 520 to power the heating device 512 so as to heat the first battery pack 510; and the power tool 50 is configured to, when the temperature is higher than or equal to the second temperature threshold, control the first battery pack 510 to power the driver circuit 230.

In an example, the weight of the battery pack 500 is less than or equal to 70% of the weight of the tool body 200. The present application sets the weight of the battery pack 500 to ensure that the battery pack 500 is not excessively heavy, thereby enhancing the user's operation experience and facilitating the placement of the power tool 50. In an example, a projection of the center of gravity of the power tool 50 on a horizontal plane falls within the range of a projection of the battery pack 500 on the horizontal plane. Thus, the power tool 50 is less shaky when being placed. In an example, the tool body 200 further includes a transmission unit 240 transmitting power outputted by an electric motor 220. In an example, the operable temperature range of the power tool 50 is from −50 degrees Celsius to 90 degrees Celsius.

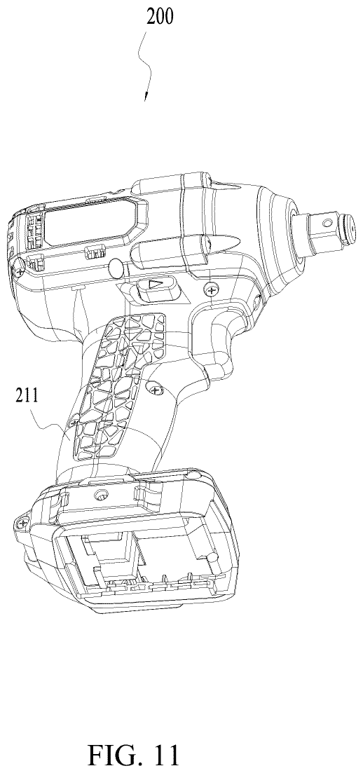

In an optional implementation, as shown in FIG. 11, the tool housing 210 includes a grip 211 for the user to hold. In an example, the battery pack partially overlaps the grip 211 so that the volume of the power tool is reduced and the miniaturization of the power tool is facilitated. In an example, the battery pack and the tool body 210 are detachable and mountable relative to each other. The battery pack and the power tool may be provided by any of the preceding examples. In an example, the electric motor 220 is a direct current motor. In an example, the electric motor 220 is a brushed motor or a brushless motor.

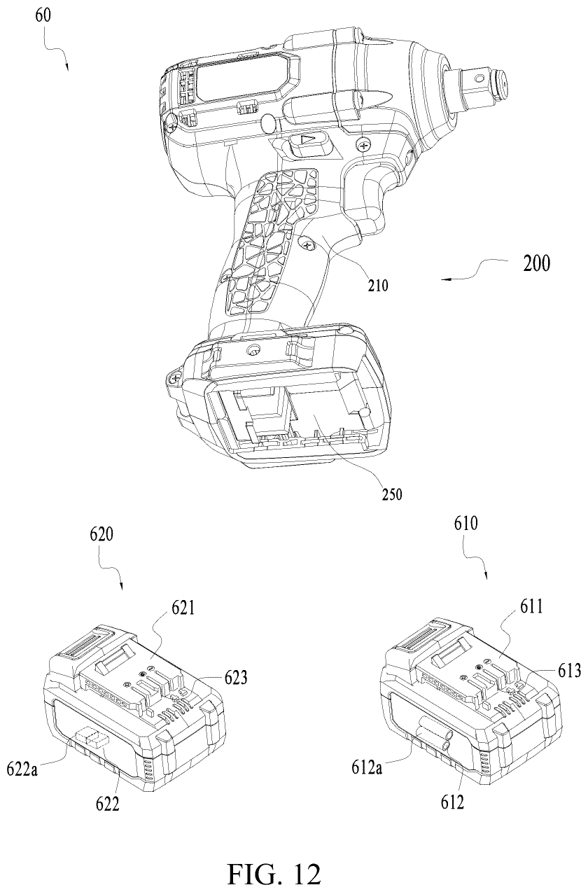

Referring to a power tool system shown in FIG. 12, the present application further provides the power tool system 60. The power tool system 60 includes a tool body 200 and a battery pack 600. The battery pack 600 is configured to supply electric power to the tool body 200. The portions in the preceding examples that are compatible with this example may be applied to this example, and only the differences between this example and the preceding examples are described below.

The power tool system 60 includes the tool body 200, a first battery pack 610, and a second battery pack 620. The tool body 200 includes a tool housing 210 and a tool interface 250 configured to access electric power.

The first battery pack 610 includes a first battery pack housing 611 and a first battery module 612 disposed in the first battery pack housing 611. The first battery module 612 includes at least one first battery cell 612a, and each of the at least one first battery cell 612a is a liquid-state battery. For example, each of the at least one first battery cell 612a may be a ternary lithium liquid-state battery or a lithium iron phosphate liquid-state battery, and the size of each of the at least one first battery cell 612a may be a 18650 cylindrical battery, a 2170 cylindrical battery, or a 4680 cylindrical battery.

The second battery pack 620 includes a second battery pack housing 621 and a second battery module 622 disposed in the second battery pack housing 621, the second battery module 622 includes at least one second battery cell 622a, and each of the at least one second battery cell 622a is a solid-state battery.

The first battery pack 610 has a first battery interface 613 that matches the tool interface 250 to allow the first battery pack 610 to power the tool body 200, and the second battery pack 620 has a second battery interface 623 that matches the tool interface 250 to allow the second battery pack 620 to power the tool body 200.

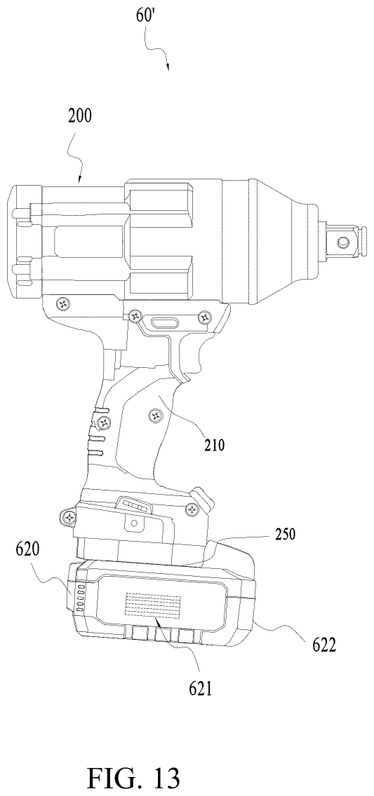

Referring to a power tool shown in FIG. 13, the present application further provides the power tool 60′. The power tool 60′ includes a tool body 200 and a battery pack 620. The battery pack 620 is configured to supply electric power to the tool body 200. The portions in the preceding examples that are compatible with this example may be applied to this example, and only the differences between this example and the preceding examples are described below.

The present application provides the power tool 60′. The power tool 60′ includes the tool body 200 and the second battery pack 620. The tool body 200 includes a tool housing 210 and a tool interface 250 configured to access electric power. As shown in FIG. 12, the tool body 200 is configured to be capable of matching a first battery pack 610 so that the tool body 200 is powered through the first battery pack 610. The first battery pack 610 includes a first battery pack housing 611 and a first battery module 612 disposed in the first battery pack housing 611, the first battery module 612 includes at least one first battery cell 612a, and each of the at least one first battery cell 612a is a liquid-state battery.

As shown in FIG. 12, the second battery pack 620 includes a second battery pack housing 621 and a second battery module 622 disposed in the second battery pack housing 621, the second battery module 622 includes at least one second battery cell 622a, and each of the at least one second battery cell 622a is a solid-state battery. The second battery pack 620 has a second battery interface 623 that matches the tool interface 250 to allow the second battery pack 620 to power the tool body 200.

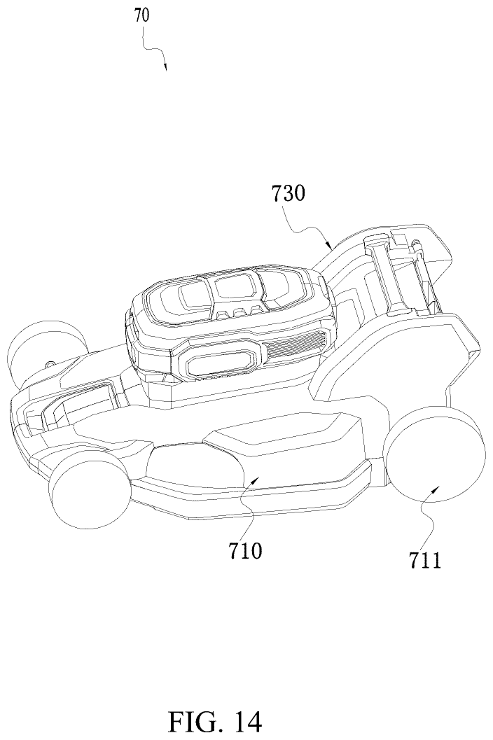

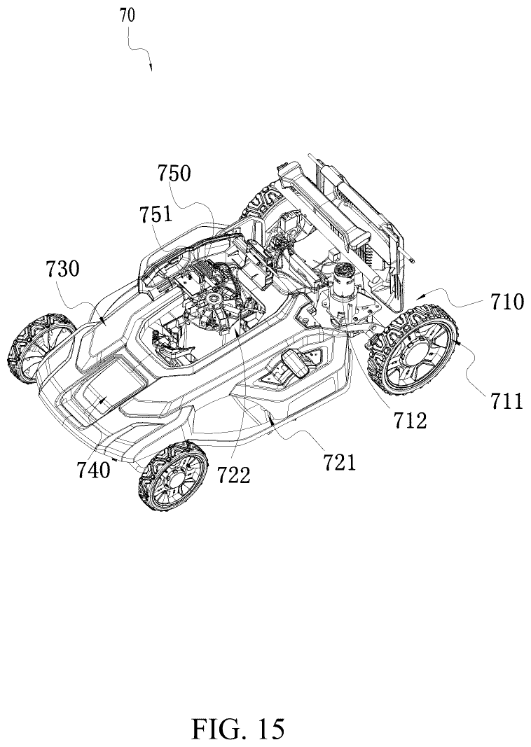

Referring to a mower shown in FIGS. 14 and 15, the present application provides the mower 70. The portions in the preceding examples that are compatible with this example may be applied to this example, and only the differences between this example and the preceding examples are described below.

The present application proposes a mowing system. With reference to FIGS. 14 and 15, the mowing system includes an execution mechanism configured to trim vegetation. The execution mechanism is the hardware that allows the mowing system to perform a mowing function. Optionally, the execution mechanism is the mower 70.

The mower 70 includes at least a cutting assembly 720 configured to perform the mowing function and a travelling device 710 configured to perform a travelling function. The mower 70 also includes a support body 740 and a machine housing 730. The machine housing 730 encases the support body 740, the cutting assembly 720, and the travelling device 710.

The travelling device 710 includes at least one driving wheel 711 and a first electric motor 712 configured to drive the at least one driving wheel 711. The first electric motor 712 supplies torque to the at least one driving wheel 711. Through the coordination of the cutting assembly 720 and the travelling device 710, the mowing system can control the execution mechanism 70 to move and work on the vegetation. The first electric motor 712 may be a direct current motor.

The cutting assembly 720 includes a mowing element 721 and a second electric motor 722. The second electric motor 722 drives the mowing element 721 to rotate and trim the vegetation. The mowing element 721 may be a blade or another element capable of cutting and trimming a lawn. The second electric motor 722 may be a direct current motor.

An energy storage device 750 is configured to power the first electric motor 712 and the second electric motor 722. The energy storage device 750 includes an energy storage unit 751. The energy storage unit 751 includes a solid-state battery. The energy storage device 750 is configured to power the travelling device 710 and the cutting assembly 720. Optionally, the energy storage device 750 is a pluggable battery pack mounted to the machine housing 730. The energy storage device 750 may be the battery pack in any of the preceding examples, and the energy storage unit 751 may be the battery cell in any of the preceding examples.

In some examples, the operable temperature range of the mower 70 is from −20 degrees Celsius to 90 degrees Celsius. In some examples, the mower 70 further includes a charging port. The charging port may be connected to another electrical energy source for charging. In some examples, a charging rate of the mower 70 is from 3 C to 10 C. The charging rate of a battery, also referred to as a charging and discharging rate, is typically represented by C. The charging rate of a battery refers to the reciprocal of the time the battery takes to be charged or discharge electricity. For example, the capacity of the battery is 10 ampere-hours (A·h), and 1 C means that the rated capacity is discharged in 1 hour. A charging rate of 3 C to 10 C means that the energy storage device 750 takes 1/10 hour to ⅓ hour to be fully charged to the rated capacity. In some examples, the energy storage device 750 adopts seal design to be water-resistant or dust-resistant. In some examples, the mower 70 can determine the electric quantity of the energy storage device 750. When the electric quantity is small, the mower 70 can automatically travel to a charging pile to be charged.

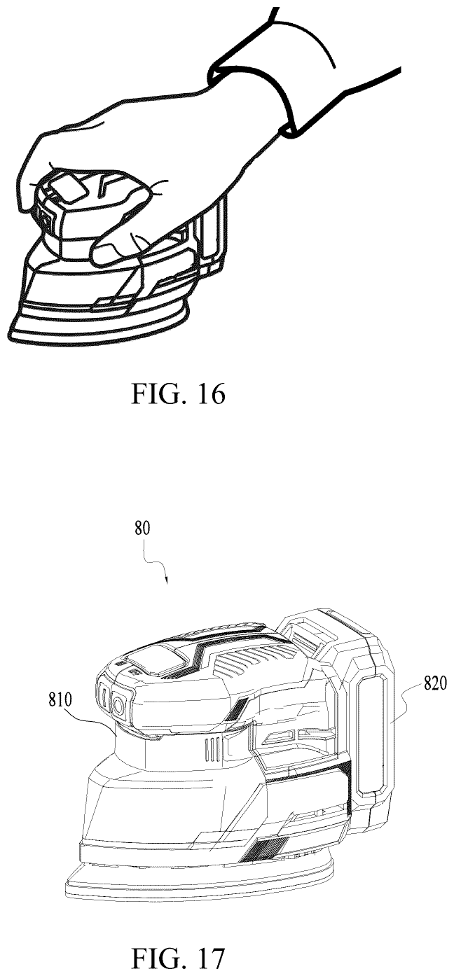

Referring to a power tool shown in FIGS. 16 to 18, the present application provides the sander 80. The portions in the preceding examples that are compatible with this example may be applied to this example, and only the differences between this example and the preceding examples are described below.

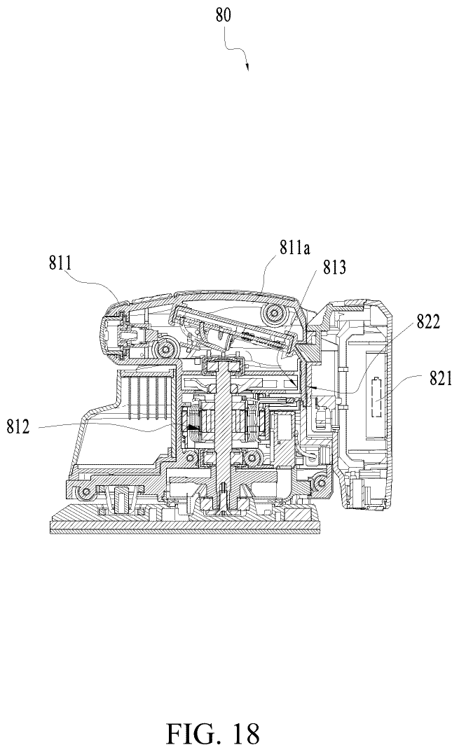

The present application provides the sander 80. As shown in FIG. 17, the sander 80 includes a sander body 810 and a battery pack 820. As shown in FIG. 18, the sander body 810 includes a tool housing 811, an electric motor 812, and a battery pack interface 813. The tool housing 811 includes a grip 811a. The electric motor 812 is disposed in the internal cavity of the tool housing 811. The battery pack interface 813 is disposed on the tool housing 811. The sander 80 further includes the battery pack 820. The battery pack 820 includes a battery cell 821 and a tool interface 822. The battery cell 821 includes a solid-state battery. The tool interface 822 is configured to be coupled to the battery pack interface 813.

In some examples, the battery pack 820 partially overlaps the grip 811a. In some examples, the battery pack 820 and the sander body 810 are detachable and mountable relative to each other. In some examples, the electric motor 812 is a direct current motor.

What is claimed is:

1. A battery pack for supplying electric power to a power tool, comprising:
a battery housing;
a battery module disposed in the battery housing and comprising a plurality of battery cells at least one of which is a solid-state battery; and
a control circuit disposed in the battery housing and configured to use the battery module to supply the electric power to the power tool;
wherein an energy W of the battery pack and a volume V1 of the battery pack satisfy the following:
when the energy W of the battery pack is greater than or equal to 200 Wh, the volume V1 of the battery pack is less than or equal to 400 cm³; or
when the energy W of the battery pack is greater than or equal to 300 Wh, the volume V1 of the battery pack is less than or equal to 800 cm³; or
when the energy W of the battery pack is greater than or equal to 700 Wh, the volume V1 of the battery pack is less than or equal to 2500 cm³.

2. The battery pack according to claim 1, wherein, when the energy W of the battery pack is greater than or equal to 350 Wh, a weight M1 of the battery pack is less than or equal to 10 kg.

3. The battery pack according to claim 1, wherein a voltage of the battery pack is higher than or equal to 18 volts.

4. The battery pack according to claim 1, wherein a ratio of the energy W of the battery pack to the volume V1 of the battery pack satisfies a relation: 0.2 Wh/cm³≤W/V1≤1 Wh/cm³.

5. The battery pack according to claim 1, wherein a ratio of the energy W of the battery pack to a weight M1 of the battery pack satisfies a relation: 1 Wh/kg≤W/M1≤35 Wh/kg.

6. The battery pack according to claim 1, wherein a ratio of the volume V1 of the battery pack to a volume V2 of the battery module satisfies a relation: 1≤V1/V2≤5.

7. The battery pack according to claim 1, wherein a length L2, a width W2, and a height H2 of the battery module satisfy relations: 1≤L2/W2≤2, 1≤L2/H2≤2, and 0.5≤W2/H2≤1.5.

8. The battery pack according to claim 1, wherein a length L2, a width W2, and a height H2 of the battery module satisfy relations: 6 cm≤L2≤20 cm, 5 cm≤H2≤15 cm, and 5 cm≤W2≤15 cm.

9. The battery pack according to claim 1, wherein a length L3, a width W3, and a height H3 of each of the plurality of battery cells satisfy relations: 10≤L3/W3≤100, 10≤L3/H3≤100, and 0.5≤W3/H3≤2.

10. The battery pack according to claim 1, wherein a length L3, a width W3, and a height H3 of each of the plurality of battery cells satisfy relations: 300 mm≤L3≤900 mm, 10 mm≤H3≤40 mm, and 10 mm≤W3≤40 mm.

11. The battery pack according to claim 1, wherein the plurality of battery cells further includes a least one liquid-state battery.

12. A battery pack for supplying electric power to a power tool, comprising:
a battery housing;
a battery module disposed in the battery housing and comprising a plurality of battery cells at least one of which is a solid-state battery;
a first interface configured to connect the power tool;
a second interface configured to access external electric power for the battery pack; and
a control circuit disposed in the battery housing, electrically connected to the battery module, the first interface, and the second interface separately, and configured to use the battery module or the external electric power to supply the electric power to the power tool.

13. The battery pack according to claim 12, wherein the external electric power is an alternating current.

14. The battery pack according to claim 12, wherein the external electric power is a direct current supplied by an external energy storage device, and the external energy storage device is independent of the battery pack.

15. The battery pack according to claim 14, wherein the external energy storage device is a lithium-ion battery pack, or a sodium-ion battery pack, or a battery pack constituted of both a lithium-ion battery and a sodium-ion battery, or a solid-state battery pack.

16. The battery pack according to claim 12, wherein the control circuit is configured to, after the second interface accesses the external electric power, control part of the external electric power to supply electric power to the power tool, control the battery pack to stop supplying the electric power to the power tool, and control part of the external electric power to charge the battery pack.

17. A power tool, comprising:
a tool body comprising a tool housing, an electric motor disposed in the tool housing, and a driver circuit electrically connected to the electric motor and configured to drive the electric motor; and
a battery pack, configured to power the tool body, comprising a battery housing, a battery module disposed in the battery housing and comprising a plurality of battery cells at least one of which is a solid-state battery, and a control circuit disposed in the battery housing and configured to use the battery module to supply the electric power to the power tool.

18. The power tool according to claim 17, wherein a weight of the battery pack is less than or equal to 70% of a weight of the tool body.

19. The power tool according to claim 17, further comprising a second battery pack, configured to power at least one of the battery pack and the driver circuit, comprising a plurality of second battery cells at least one of which is configured as a liquid-state battery.

20. The power tool according to claim 17, further comprising a second battery pack comprising a second battery pack housing and a second battery module, disposed in the second battery pack housing, comprising a least one second battery cell, wherein the at least one second battery cell is a liquid-state battery, the battery pack has a first battery interface that matches the tool body to allow the battery pack to power the tool body, and the second battery pack has a second battery interface that matches the tool body to allow the second battery pack to power the tool body.
